(19) United States
(12) Patent Application Publication
(10) Pub. No.: US 2020/0142075 A1
(43) Pub. Date: May 7, 2020

(54) LIDAR SYSTEM AND AUTONOMOUS DRIVING SYSTEM USING THE SAME

(71) Applicant: LG ELECTRONICS INC., Seoul (KR)

(72) Inventor: Jejong LEE, Seoul (KR)

(21) Appl. No.: 16/553,471

(22) Filed: Aug. 28, 2019

(30) Foreign Application Priority Data
Jul. 31, 2019 (KR) 10-2019-0092941

(51) Int. Cl. G01S 17/931; G01S 17/90; G05D 1/02; G05D 1/00

(52) U.S. Cl. CPC G01S 17/931; G05D 1/0088; G05D 1/024; G01S 17/90

(57) ABSTRACT

A lidar system includes: first and second light sources generating first and second light in shapes of a point light source and a linear light source, respectively; an optical element reflecting the first light and transmitting the second light; a first scanner vertically reciprocating the first light from the optical element; a second scanner horizontally reciprocating the first and second light from the optical element; a first light receptor converting the first light reflected by an object at a long distance into an electrical signal; and a second light receptor converting the second light reflected by an object at short and medium distances into an electrical signal. According to the lidar system, an autonomous vehicle, AI device, and/or external device may be linked with an artificial intelligence module, drone (Unmanned Aerial Vehicle, UAV), robot, AR (Augmented Reality) device, VR (Virtual Reality) device, a device associated with 5G services, etc.

### CROSS-REFERENCE TO RELATED APPLICATION

This application claims the benefit of Korean Patent Application No. 10-2019-0092941 filed on Jul. 31, 2019, the entire contents of which are incorporated herein by reference for all purposes as if fully set forth herein.

### BACKGROUND

### Field of the Disclosure

The present disclosure relates to an autonomous driving system and a control method thereof and, more particularly, to a lidar system having two laser light sources, and an autonomous driving system using the lidar system.

### Description of the Background

Vehicles, in accordance with the prime mover that is used, can be classified into an internal combustion engine vehicle, an external combustion engine vehicle, a gas turbine vehicle, an electric vehicle or the like.

An autonomous vehicle refers to a vehicle that can be driven by itself without operation by a driver or a passenger and an autonomous driving system refers to a system that monitors and controls such an autonomous vehicle so that the autonomous vehicle can be driven by itself.

### SUMMARY

Since autonomous vehicles are driven without intervention of a driver, the autonomous vehicles need various sensors to quickly and accurately sense surrounding landforms and objects in real time.

Lidar (Light Imaging Detection and Ranging) radiates laser light pulses to an object and analyzes light reflected by the object, thereby being able to sense the size and disposition of the object and to map the distance from the object. Lidar includes a scanner to radiate light radiated as laser pulses in various directions. The scanner may be implemented by a galvano scanner and a MEMS (MicroElectro Mechanical Systems) scanner. The MEMS scanner has an advantage of speed, size, weight, low power, and cost in comparison to the galvano scanner.

Recently, a solid state lidar is usually developed in a scan type that uses the MEMS scanner. In two dimensional (2D) canning of light using the MEMS scanner, there is a limitation in sensing distance due to a limited scan speed (or frame rate). In order to overcome the limitation of sensing distance, it is required to increase the power of a laser light source, but in this case, the retinas of human may be injured by high-power laser light. It is possible to select a laser light source with a laser wavelength that satisfies an eye-safety condition that causes little injuries on retinas, but this laser light source is expensive and large in size.

MEMS scanners that are used in liar systems are manufactured in large sizes to two-dimensionally move the direction of light, so the productivity is low and the manufacturing cost is high.

Since lidar systems of the related art have a view of angle fixed regardless of distances, they cannot cope with various use cases.

An object of the present disclosure is to solve the necessities and/or problems described above.

An object of the present disclosure is to provide a lidar system that can be implemented in a small and light size and can cope with various use cases, and an autonomous driving system using the lidar system.

The objects of the present disclosure are not limited to the objects described above and other objects will be clearly understood by those skilled in the art from the following description.

A lidar system according to an embodiment of the present disclosure includes: a first light source that generates first light in the shape of a point light source; a second light source that generates second light in the shape of a linear light source; a selective reflective optical element that reflects the first light and transmits the second light; a first scanner that vertically reciprocates the first light traveling from the selective reflective optical element; a second scanner that horizontally reciprocates the first and second light traveling from the selective reflective optical element; a first light reception unit that converts the first light reflected by an object at a long distance into an electrical signal; and a second light reception unit that converts the second light reflected by an object at a short distance and a medium distance in to an electrical signal.

An autonomous driving control system according to an embodiment of the present disclosure includes: an object detection device that detects an object outside a vehicle using a lidar system; and an autonomous device that receives object information from the object detection device and reflects the object information to movement control of the vehicle.

### BRIEF DESCRIPTION OF THE DRAWINGS

Accompanying drawings included as a part of the detailed description for helping understand the present disclosure provide embodiments of the present disclosure and are provided to describe technical features of the present disclosure with the detailed description.

The accompanying drawings, which are included to provide a further understanding of the disclosure and are incorporated in and constitute a part of this specification, illustrate embodiments of the disclosure and together with the description serve to explain the principles of the disclosure. In the drawings:

FIG. 1 is a block diagram of a wireless communication system to which methods proposed in the disclosure are applicable.

FIG. 2 is a diagram showing an example of a signal transmission/reception method in a wireless communication system.

FIG. 3 shows an example of basic operations of a user equipment and a 5G network in a 5G communication system.

FIG. 4 shows an example of a basic operation between vehicles using 5G communication.

FIG. 5 is a diagram showing a vehicle according to an embodiment of the present disclosure.

FIG. 6 is a control block diagram of the vehicle according to an embodiment of the present disclosure.

FIG. 7 is a control block diagram of an autonomous device according to an embodiment of the present disclosure.

FIG. 8 is a signal flow diagram of an autonomous device according to an embodiment of the present disclosure.

FIG. 9 is a diagram showing a V2X application.

FIGS. 10A and 10B are diagrams showing a resource allocation method in V2X sidelink.

FIG. 11 is a block diagram showing a lidar system according to an embodiment of the present disclosure.

FIG. 12 is a diagram showing a sensing distance of a lidar system.

FIG. 13 is a diagram showing in detail light emission units according to a first embodiment of the present disclosure.

FIG. 14 is a diagram showing first and second light reception units.

FIG. 15 is a diagram showing in detail a light emission unit according to a second embodiment of the present disclosure.

FIG. 16 is a block diagram showing a light source control unit.

### DETAILED DESCRIPTION OF THE EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereafter, a device that requires autonomous driving information and/or 5G communication (5th generation mobile communication) that an autonomous vehicle requires are described through a paragraph A to a paragraph G

A. Example of Block Diagram of UE and 5G Network

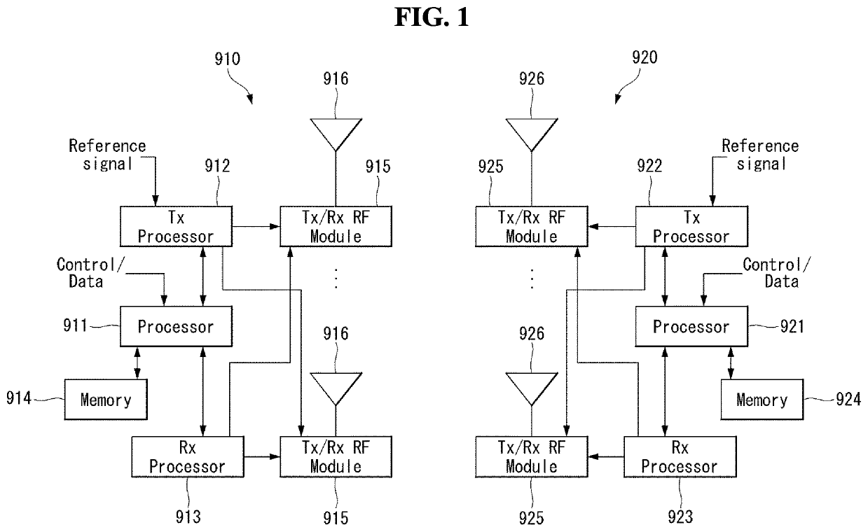

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

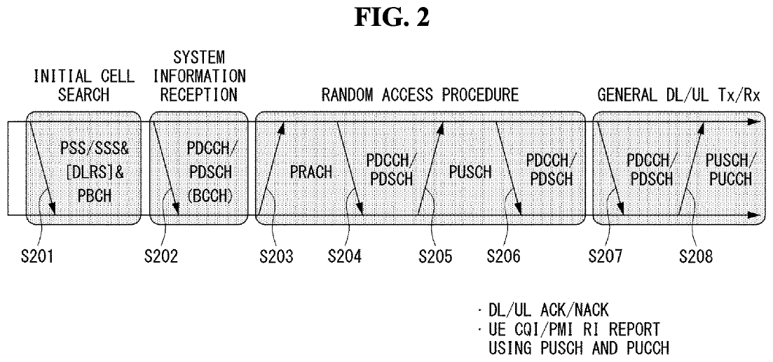

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps 5203 to S206). To this end, the UE can transmit a specific sequence as a preamble through a physical random access channel (PRACH) (S203 and 5205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.

A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.

The UE receives the signals on SSB resources from the BS on the basis of the CSI-SSB-ResourceSetList.

When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.

The UE receives an NZP CSI-RS resource set IE including an RRC parameter with respect to ‘repetition’ from a BS through RRC signaling. Here, the RRC parameter ‘repetition’ is set to ‘ON’.

The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.

The UE determines an RX beam thereof

The UE skips a CSI report. That is, the UE can skip a CSI report when the RRC parameter ‘repetition’ is set to ‘ON’.

Next, the Tx beam determination procedure of a BS will be described.

A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.

The UE receives signals on resources in a CSI-RS resource set in which the RRC parameter ‘repetition’ is set to ‘OFF’ in different DL spatial domain transmission filters of the BS.

The UE selects (or determines) a best beam.

The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.

A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.

When SRS-SpatialRelationlnfo is set for SRS resources, the same beamforming as that used for the SSB, CSI-RS or SRS is applied. However, when SRS-SpatialRelationlnfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation between Autonomous Vehicles using SG Communication

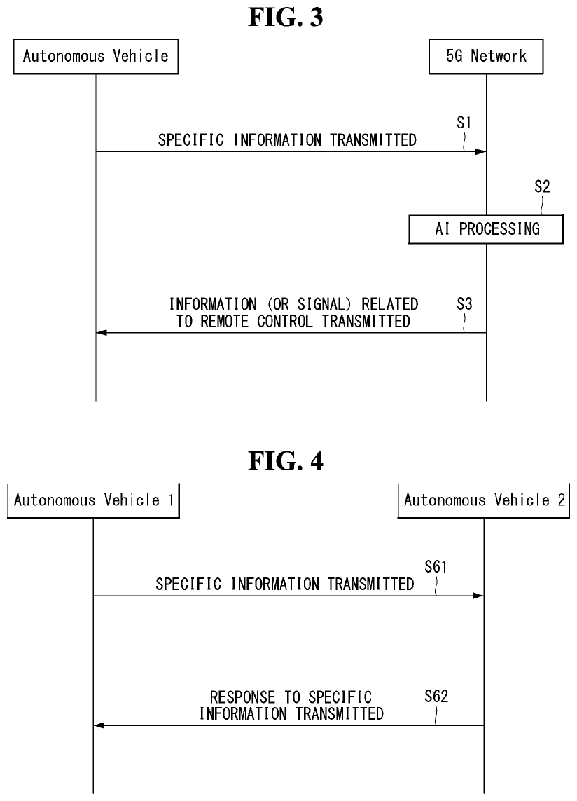

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G Applied Operations between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present disclosure which will be described later and eMBB of 5G communication are applied will be described.

As in steps 51 and S3 of FIG. 3, the autonomous vehicle performs an initial access procedure and a random access procedure with the 5G network prior to step 51 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present disclosure which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present disclosure which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation between Vehicles using 5G Communication

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present disclosure which will be described later and applied or can complement the methods proposed in the present disclosure to make technical features of the methods concrete and clear.

Driving

(1) Exterior of Vehicle

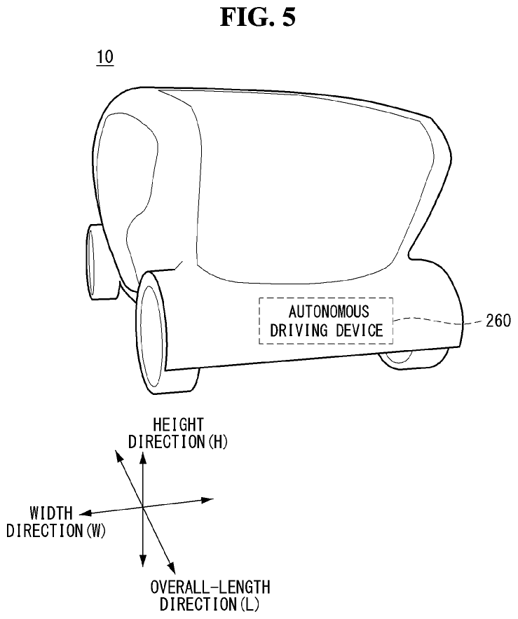

FIG. 5 is a diagram showing a vehicle according to an embodiment of the present disclosure.

Referring to FIG. 5, a vehicle 10 according to an embodiment of the present disclosure is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

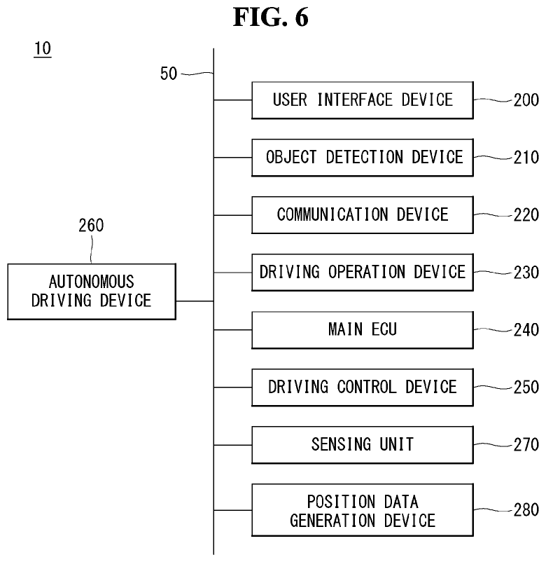

FIG. 6 is a control block diagram of the vehicle according to an embodiment of the present disclosure.

Referring to FIG. 6, the vehicle 10 may include a user interface device 200, an object detection device 210, a communication device 220, a driving operation device 230, a main ECU 240, a driving control device 250, an autonomous driving device 260, a sensing unit 270, and a position data generation device 280. The object detection device 210, the communication device 220, the driving operation device 230, the main ECU 240, the driving control device 250, the autonomous driving device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3) Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present disclosure can exchange signals with external devices using only one of C-V2X and DSRC. Alternatively, the communication device of the present disclosure can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous driving device 260. For example, the driving control device 250 can control a power train, a steering device and a brake device on the basis of signals received by the autonomous driving device 260.

7) Autonomous Device

The autonomous driving device 260 can generate a route for self-driving on the basis of acquired data. The autonomous driving device 260 can generate a driving plan for traveling along the generated route. The autonomous driving device 260 can generate a signal for controlling movement of the vehicle according to the driving plan. The autonomous driving device 260 can provide the signal to the driving control device 250.

The autonomous driving device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous driving device 260 can perform switching from a self-driving mode to a manual driving mode or switching from the manual driving mode to the self-driving mode. For example, the autonomous driving device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

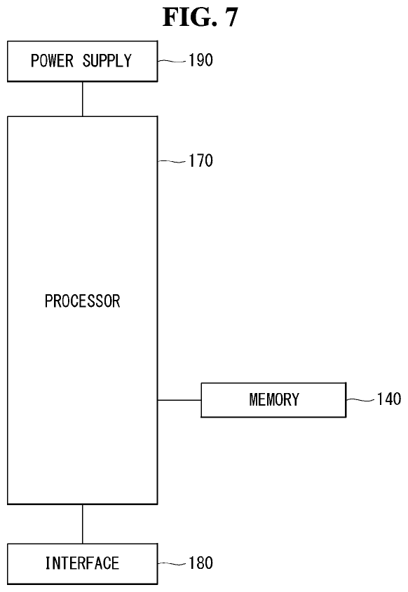

FIG. 7 is a control block diagram of the autonomous device according to an embodiment of the present disclosure.

Referring to FIG. 7, the autonomous driving device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous driving device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner.

The interface 180 can be configured using at least one of a communication module, a terminal, a pin, a cable, a port, a circuit, an element and a device.

The power supply 190 can provide power to the autonomous driving device 260. The power supply 190 can be provided with power from a power source (e.g., a battery) included in the vehicle 10 and supply the power to each unit of the autonomous driving device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous driving device 260 may include at least one printed circuit board (PCB). The memory 140, the interface 180, the power supply 190 and the processor 170 may be electrically connected to the PCB.

(4) Operation of Autonomous Device

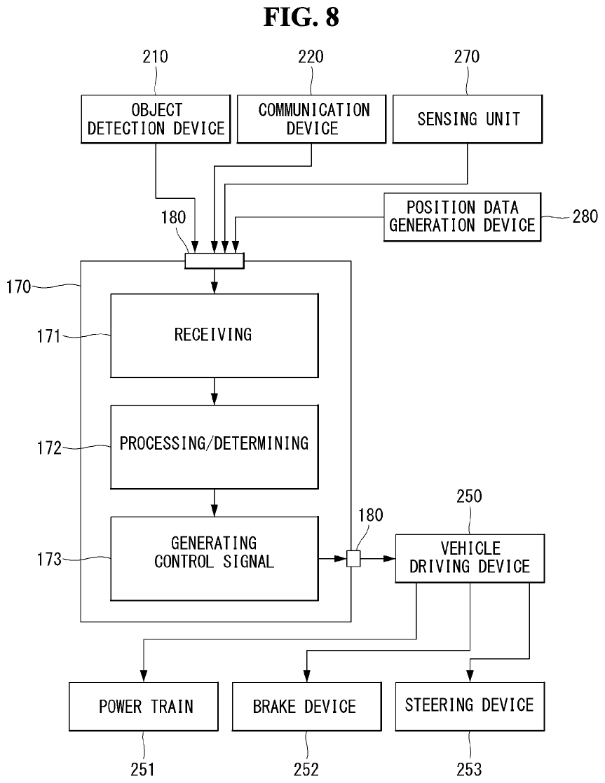

FIG. 8 is a diagram showing a signal flow in an autonomous vehicle according to an embodiment of the present disclosure.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 254.

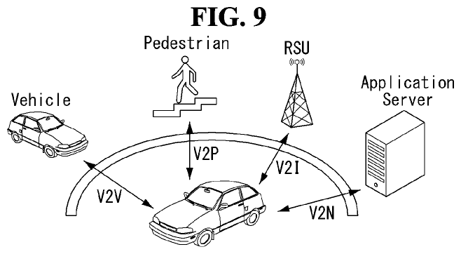

FIG. 9 shows an example of types of V2X applications.

Referring to FIG. 9, V2X communication includes communication between a vehicle and all entities such as V2V (Vehicle-to-Vehicle) referring to communication between vehicles, V2I (Vehicle to Infrastructure) referring to communication between a vehicle and an eNB or an RSU (Road Side Unit), V2P (Vehicle-to-Pedestrian) referring to communication between a vehicle and a UE that an individual (a pedestrian, a bicycle rider, a driver or a passenger in a vehicle) has, and V2N(vehicle-to-network).

V2X communication may refer to the same meaning as V2X sidelink or NR V2X or may refer to a wider meaning including V2X sidelink or NR V2X.

V2X communication may be applied to various services, for example, front collision warning, an automatic parking system, cooperative adaptive cruise control (CACC), control loss warning, traffic line warning, traffic vulnerable person safety warning, emergency vehicle warning, speed warning when driving on a bending road, and traffic flow control.

V2X communication can be provided through a PC5 interface and/or a Uu interface. In a wireless communication system that supports V2X communication, specific network entities for supporting communication between the vehicle and all entities may exist. For example, the network entities may be a BS (eNB), an RSU (road side unit), an application server (e.g., traffic safety server), or the like.

A UE that performs V2X communication may mean not only a common handled UE, but also a robot including a vehicle UE (V-UE), a pedestrian UE, a BS type (eNB type) RSU, a UE type (RSU), or a communication module, etc.

V2X communication may be directly performed between UEs or may be performed through the network entity (entities). A V2X operation mode can be classified in accordance with the performance manner of V2X communication.

V2X communication is required to support pseudonymity and privacy of a UE when using V2X applications such that an operator or a third part cannot track UE identity in an area where V2X is supported.

Terms that are frequently used in V2X communication are defined as follows.

RSU (Road Side Unit): An RSU is a V2X service-enabled device that can perform transmission/reception to/from a moving vehicle using a V2I service. Further, the RSU, which is a fixed infra entity supporting V2X applications, can exchange messages with another entity supporting the V2X applications. The RSU is a term that is frequently used in an existing ITS spec and the reason of introducing this term in a 3GPP spec is for enabling easily reading documents in an ITS industry. The RUS is a logical entity that combines an V2X application logic with the function of a BS (referred to as a BS-type RUS) or a UE (referred to as a UE-type RSU).

V2I service: A type of V2X service and an entity of which a side pertains to a vehicle and the other side pertains to an infrastructure.

V2P service: A type of V2X service in which a side is vehicle and the other side is a device that an individual has (e.g., a mobile UE device that a pedestrian, a bicycle rider, a driver, or a passenger carries).

V2X service: A 3GPP communication service type in which a transmission or reception device is related to a vehicle.

V2X-enabled UE: A UE supporting a V2X service.

V2V service: A V2X service type in which both sides of communication are vehicles.

V2V communication range: A direct communication range of two vehicles participating in a V2V service.

As V2X applications called V2X (Vehicle-to-Everything), as described above, there are four types of (1) vehicle-to-vehicle, (2) vehicle-to-infra, (3) vehicle-to-network (V2N), and (4) vehicle-to-pedestrian (V2P).

V2X communication can provide V2X applications of four types such as V2V, V2P, V2I, and V2N. These four types of V2X applications may use “co-operative awareness” to provide more intelligent services for end users. This refers to collecting knowledge (e.g., information received from an adjacent other vehicle or sensor equipment) regarding a corresponding area environment for entities such as a vehicle, a road-based facility, an application server, and a pedestrian to handle and share the corresponding knowledge to provide intelligent information such as cooperation collision warning or autonomous driving.

These intelligent transport services and related message sets are defined in automotive standards developing organizations (SDOs) outside 3GPP.

Three basic classes for providing ITS services: road safety, traffic efficiency and other applications are described in, for example, ETSI TR 102 638 V1.1.1: “Vehicular Communications; Basic Set of Applications; Definitions”.

A radio protocol architecture for a user plane for V2X communication and a radio protocol architecture for a control plane for V2X communication may be basically the same as a protocol stack architecture for sidelink. for the user plane includes a packet data convergence protocol (PDCP), a radio link control (RLC), a medium access control (MAC), and a physical layer (PHY), and the radio protocol architecture for the control plane may include radio resource control (RLC), an RLC, a MAC, and a physical layer. Further details of the protocol stack for V2X communication may refer to 3GPP TS 23.303, 3GPP TS 23.285, 3GPP TS 24.386, and the like.

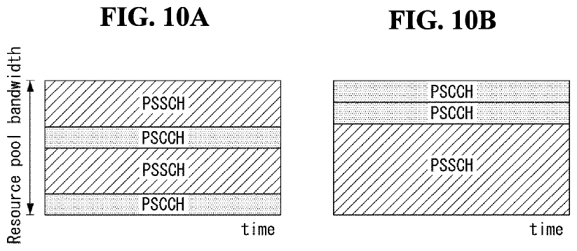

FIGS. 10A and 10B exemplify a resource allocation method in a sidelink in which V2X is used.

In the sidelink, as shown in FIG. 10A, different sidelink control channels (PSCCHs) may be allocated and spaced apart from each other in the frequency domain, and different sidelink shared channels (PSSCHs) may be allocated and spaced apart from each other. Alternatively, as shown in FIG. 10B, different PSCCHs may be consecutively allocated in the frequency domain and PSSCHs may also be consecutively allocated in the frequency domain.

In time division multiple access (TDMA) and frequency division multiple access (FDMA) systems, accurate time and frequency synchronization is essential. If time and frequency synchronization is not accurate, intersymbol interference (ISI) and intercarrier interference (ICI) may arise to degrade system performance. This is the same with V2X as well. In V2X, a sidelink synchronization signal (SLSS) may be used in the physical layer and master information block-sidelink-V2X (MIB-SL-V2X) may be used in the radio link control (RLC) layer for time/frequency synchronization.

A source of synchronization or criteria of synchronization in V2X will be described. The UE may acquire information about time/frequency synchronization from at least one of global navigation satellite systems (GNSS), serving cell (BS), or other neighboring UEs.

Specifically, the UE may be directly synchronized to the GNSS or synchronized to another UE that is time/frequency synchronized to the GNSS. In a case where the GNSS is configured as a synchronous source, the UE may calculate a DFN and a subframe number using coordinated universal time (UTC) and (pre)configured DFN (direct frame number) offset.

Alternatively, the UE may be directly synchronized to the BS or synchronized to another UE that is time/frequency synchronized to the BS. For example, if the UE is within network coverage, the UE may receive synchronization information provided by the BS and may be directly synchronized to the BS. Thereafter, the UE may provide the synchronization information to another neighboring UE. if a BS timing is configured as a criterion for synchronization, the UE may follow a cell associated with a corresponding frequency (if within the cell coverage at the frequency) or follow a primary cell or a serving cell (when outside the cell coverage at the frequency) for synchronization and downlink measurements.

A serving cell (BS) may provide a synchronization setup for a carrier used for V2X sidelink communication. In this case, the UE may follow the synchronization setup received from the BS. If no cell is detected from the carrier used for the V2X sidelink communication and no synchronization setup is received from the serving cell, the UE may follow a preset synchronization setup.

Alternatively, the UE may be synchronized to another UE that has not acquired the synchronization information either directly or indirectly from the BS or the GNSS. The source and preference of synchronization may be previously set to the UE or may be set via a control message provided by the BS.

The SLSS may be a sidelink-specific sequence and may include a primary sidelink synchronization signal (PSSS) and a secondary sidelink synchronization signal (SSSS).

Each SLSS may have a physical layer sidelink synchronization identity, and the value may be, for example, any of 0 to 335. A synchronization source may be identified depending on which of the above values is used. For example, 0, 168, and 169 may refer to Global Navigation Satellite System (GNSS), 1 to 167 may refer to BS, and 170 to 335 may refer to outside coverage. Alternatively, values 0 to 167 among the physical layer sidelink synchronization ID are values used by the network, and 168 to 335 may be values used outside the network coverage.

The UE providing synchronization information to another UE may be considered to operate as a synchronization reference. The UE may additionally provide information on synchronization together with the SLSS via a SL-BCH (sidelink broadcast channel).

There are transmission modes 1, 2, 3 and 4 in the sidelink.

In a transmission mode 1/3, the BS performs resource scheduling through the PDCCH (more specifically, DCI) to the UE 1, and the UE 1 performs D2D/V2X communication with the UE 2 according to the resource scheduling. The UE 1 may transmit sidelink control information (SCI) through the physical sidelink control channel (PSCCH) to the UE 2 and then transmit the data based on the SCI through a physical sidelink shared channel (PSSCH). Transmission mode 1 may be applied to D2D, and transmission mode 3 may be applied to V2X.

The transmission mode 2/4 may be a mode in which the UE performs scheduling by itself. More specifically, the transmission mode 2 is applied to the D2D, and the UE may perform the D2D operation by selecting resource by itself from the configured resource pool. Transmission mode 4 is applied to V2X, and the UE may perform a V2X operation after selecting resources by itself from a selection window through a sensing process. The UE 1 may transmit the SCI through the PSCCH to the UE 2 and then transmit the data based on the SCI through the PSSCH. Hereinafter, the transmission mode may be abbreviated as a mode.

The control information transmitted by the BS to the UE through the PDCCH is referred to as DCI (downlink control information), while the control information transmitted by the UE to the other UE through the PSCCH may be referred to as SCI. The SCI may convey sidelink scheduling information. There may be several formats in SCI, for example, SCI format 0 and SCI format 1.

SCI format 0 may be used for scheduling of the PSSCH. The SCI format 0 may include a frequency hopping flag (1 bit), a resource block allocation and a hopping resource allocation field (the number of bits may vary depending on the number of resource blocks of the sidelink), a time resource pattern, an MCS (modulation and coding scheme), a time advance indication, a group destination ID, and the like.

The SCI Format 1 may be used for scheduling of the PSSCH. The SCI format 1 includes priority, resource reservation, frequency resource location of initial transmission and retransmission (the number of bits may vary depending on the number of subchannels of the sidelink), a time gap between initial transmission and retransmission, MCS, retransmission index, and the like.

The SCI format 0 may be used for transmission modes 1 and 2, and the SCI format 1 may be used for transmission modes 3 and 4.

Hereinafter, resource allocation in mode 3 and mode 4 applied to V2X will be described in detail. First, mode 3 will be described.

Mode 3 may be scheduled resource allocation. The UE may be in RRC_CONNECTED state to transmit data.

FIGS. 10A and 10B illustrate a case where a UE performs a mode 3 operation.

The UE may request the BS for transmission/reception resources, and the BS may schedule the resource(s) for the UE regarding the sidelink control information and/or transmission/reception of data. Here, a sidelink SPS may be supported for scheduled resource allocation. The UE may transmit/receive sidelink control information and/or data with another UE using the allocated resources.

The UE may request the BS for transmission/reception resources, and the BS may schedule the resource(s) for the UE regarding the sidelink control information and/or transmission/reception of data. Here, a sidelink SPS may be supported for scheduled resource allocation. The UE may transmit/receive sidelink control information and/or data with another UE using the allocated resources.

Mode 4 may be UE autonomous resource selection. The UE may perform sensing for (re)selection of sidelink resources. The UE may randomly select/reserve sideline resource among remaining resources excluding specific resource on the basis of a sensing result. The UE may perform up to two parallel independent resource reservation processes.

As described above, the UE may perform sensing to select a mode 4 transmission resource.

For example, the UE may recognize transmission resources reserved by other UEs or resources used by other UEs through sensing in a sensing window, exclude the same from the selection window, and randomly select resource from less-interfered resource among the remaining resources.

For example, within a sensing window, the UE may decode a PSCCH including information on a period of the reserved resources and measure a PSSCH RSRP on the periodically determined resources on the basis of the PSCCH. Resources whose PSSCH RSRP value exceeds a threshold may be excluded from the selection window. Thereafter, the UE may randomly select sidelink resources from the remaining resources in the selection window.

The UE may measure received signal strength indication (RSSI) of periodic resources in the sensing window to identify resources with less interference corresponding to lower 20%, for example. The UE may then select sidelink resource among the resources included in the selection window among the periodic resources. For example, such a method may be used if decoding of PSCCH fails.

The 5G communication technology described above can be applied in combination with methods proposed in the present disclosure to be described below or can be added to make the technical characteristics of the methods proposed in the present disclosure embodied or clear.

Hereafter, a lidar system and an autonomous driving system using the lidar system according to an embodiment of the present disclosure are described in detail. According to a lidar system of the present disclosure, one or more of an autonomous vehicle, an AI device, and an external device may be linked with an artificial intelligence module, a drone ((Unmanned Aerial Vehicle, UAV), a robot, an AR (Augmented Reality) device, a VR (Virtual Reality) device, a device associated with 5G services, etc. Hereafter, embodiments will be described mainly with reference to an example in which a lidar system is applied to an autonomous vehicle, but it should be noted that the present disclosure is not limited thereto.

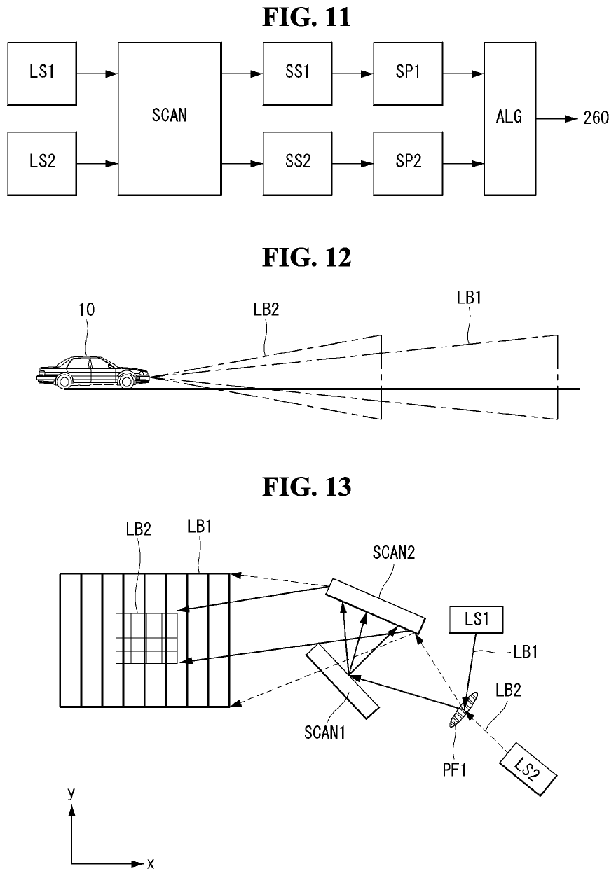

The object detection device 210 may include the lidar system of FIGS. 11 to 15.

FIG. 11 is a block diagram showing a lidar system according to an embodiment of the present disclosure. FIG. 12 is a diagram showing a sensing distance of a lidar system.

Referring to FIGS. 11 and 12, the lidar system includes light emission units LS1, LS2, and SCAN, light reception units SS1 and SS2, signal processing units SP1 and SP2, and an object determination unit ALG.

The light emission units LS1, LS2, and SCAN includes a first light emission unit LS1, a second light emission unit LS2, and a light scan unit SCAN.

The first and second emission units LS1 and LS2 generate laser light pulses. The first emission unit LS1 may be used as a light source that implements a narrow VOA for long-distance sensing, as shown in FIG. 12. The second emission unit LS2 may be used as a light source that implements a wide VOA for short-distance and medium-distance sensing, as shown in FIG. 12. Here, the short distance may be a distance of 20-50 m from a vehicle. The medium distance may be a distance of 50m from a vehicle. The long distance may be a distance of over 100 m from a vehicle.

The first and second emission units LS1 and LS2 can generate laser light with the same wavelength or different wavelengths. The laser light wavelength may be 905 nm or 1550 nm.

The laser light source of 905 nm can be implemented as a semiconductor diode laser based in InGaAs/GaAs and can emit laser light of high power. The peak power of the semiconductor diode laser based in InGaAs/GaAs is 25W in one emitter. In order to increase the power of the semiconductor diode laser based on InGaAs/GaAs, three emitters are combined in a stack structure, thereby being able to output laser light of 75W. The semiconductor diode laser based on InGaAs/GaAs an be implemented in a small size at a low cost. The driving modes of the semiconductor diode laser based on InGaAs/GaAs are a spatial mode and a multi mode.

The laser light source of 1550 nm can be implemented as a fiber laser, a DPSS (Diode Pumped Solid State) laser, a semiconductor diode laser, etc. As a representative example of the fiber laser, there is an erbium-doped fiber laser. The fiber laser of 1550 nm can emit a laser of 1550 nm through an erbium-doped fiber, using a diode laser as a pump laser. The peak power of the fiber laser of 1550 nm can be up to several kW. The operation modes of the fiber laser of 1550 nm are a spatial mode and a few mode. The light quality is high and the aperture size is small in the fiber laser of 1550 nm, so it is possible to detect an object with high resolution. The DPSS laser can emit laser light of 1534 nm through a laser crystal such as MgAlO and YVO, using a diode layer as a pump laser. The semiconductor diode layer of 1550 nm can be implemented as a semiconductor diode layer based on InGaAsP/InP and the peak power thereof is tens of watt (W). The semiconductor diode layer of 1550 nm is smaller in size than the fiber laser.

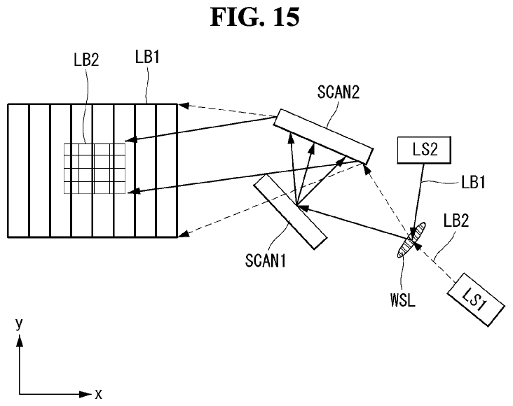

The light scan unit SCAN scans light for long-distance sensing at a narrow VOA by moving a first laser beam traveling inside from the first light emission unit LS2 at a narrow angle from two axial directions (x, y) perpendicular to each other. The light scan unit SCAN scans light for short-distance and medium-distance sensing at a wide VOA by moving a second laser beam traveling inside from the second light emission unit LS2 at a wide angle from one axial direction (x). The light scan unit SCAN, as shown in FIG. 13 or FIG. 15, moves the light traveling inside from the first and second light emission units LS1 and LS2 in two axial directions (x, y) perpendicular to each other, using one selective reflective optical element and two one-dimensional (1D) scanners.

The light reception units SS1 and SS2 convert light reflected by an object into an electrical signal, using a photoelectric transformation element, for example, a photodiode. The light reception units SS1 and SS2 may be divided into a first light reception unit SS1 and a second light reception unit SS2. The first light reception unit SS1 converts first light (LB1 in FIG. 12) reflected and received from an object into a current. The second light reception unit SS2 converts second light LB2 reflected and received from an object into a current.

The signal processing units SP1 and SP2 convert the output of the first and second light reception units SS1 and SS2 into a voltage, amplify the voltage, and then convert amplified signals into digital signals using an analog digital converter (ADC). The signal processing units SP1 and SP2 may be divided into a first signal processing unit SP1 and a second signal processing unit SP2. The first signal processing unit SP1 outputs data for long-distance sensing by current-voltage-converting, amplifying, and converting an output signal of the first light reception unit SS1 into digital data. The second signal processing unit SPs outputs data for medium-distance and long-distance sensing by current-voltage-converting, amplifying, and converting an output signal of the second light reception unit SS1 into digital data. The first and second signal processing units SP1 and SP2 can share circuit configuration elements by time-divisionally processing output signals of the first and second light reception units SS1 and SS2.

The object determination unit ALG detects distances from objects, and shapes by analyzing data from the first and second signal processing units SP1 and SP2, using a TOF (Time of Flight) algorithm or a phase-shift algorithm.

The autonomous driving device 260 can reflect object information input from the object determination unit ALG to a motion control signal of the vehicle. For example, the autonomous driving device 260 can change the speed, steering direction, etc. of the vehicle or can control an evasive maneuver of the vehicle, depending on objects detected by the lidar system.

FIG. 13 is a diagram showing in detail light emission units according to a first embodiment of the present disclosure.

Referring to FIG. 13, laser light sources of the first light emission unit LS1 and the second light emission unit LS2 are spaced a predetermined apart from each other. Light that is radiated from the first and second light emission units LS1 and LS2 may be laser light pulses with the same wavelength.

The polarization characteristics of the light that is radiated from the first and second light emission units LS1 and LS2 may be different. For example, the laser light source of the first light emission unit LS1 can radiate light as a first polarized laser pulse that vibrates on a first optical axis. The light that is radiated from the second light emission unit LS2 can be radiated as a second polarized laser pulse that vibrates on a second optical axis perpendicular to the first optical axis.

The laser light source of the first light emission unit LS1 may be a point light source that radiates light pulses in the shape of a point. The laser light source of the second light emission unit LS2 may be a linear light source that radiates light pulses in the shape of a long line in the y-axial direction.

The light scan unit SCAN includes a polarizing filter PF, a first scanner SCAN1, and a second scanner SCAN2.

Laser pulses that are radiated from the first and second light sources LS1 and LS2 can be radiated with a predetermined time difference. In this case, the first light LB1 and the second light LB2 may alternately or time-divisionally travel into the polarizing filter PF.

The polarizing filter PF is disposed between the first light source LS1, the second light source LS2, and the first and second scanners SCAN1 and SCAN2. The light traveling into the polarizing filter PF passes through or is reflected by the polarizing filter PF, depending on the polarizing characteristic. For example, first polarized light is reflected by the polarizing filter PF, but second polarized light passes through the polarizing filter PF.

The first light LB1 that is radiated from the first light source LS1 vibrates into first polarized light. The second light LB2 that is radiated from the second light source LS2 vibrates into second polarized light. In this case, the first light LB1 is reflected by the polarizing filter PF and travels to the first scanner SCAN1. On the other hand, the second light LB2 passes through the polarizing filter PF and then travels to the second canner SCAN2.

The first scanner SCAN1 and the second scanner SCAN2 are one-dimensional scanners that vibrate in directions perpendicular to each other. The first scanner SCAN1 and the second scanner SCAN2 may be implemented as MEMS scanners that vibrate in accordance with the resonance frequency of an input signal.

The first scanner SCAN1 vibrates in the vertical (y-axial) direction about a rotational axis within a predetermined rotational angle range. Light traveling in the first scanner SCAN1 scans an object by vertically reciprocating. Light that is reflected by the first scanner SCAN1 is converted into light for long-distance sensing at a narrow VOA, thereby being able to scan an object in the y-axial direction. The rotational angle of the first scanner SCAN1 may be smaller than that of the second scanner SCAN2.

The second scanner SCAN2 vibrates in the horizontal direction, that is, in the x-axial direction perpendicular to the y-axial direction around a rotational axis within a predetermined angle range. Light traveling in the second scanner SCAN2 scans an object by horizontally reciprocating. The first light LB1 that is reflected by the second scanner SCAN2 is converted into light for long-distance sensing at a narrow VOA and then scans an object in the x-axial direction. The second light LB2 that is reflected by the second scanner SCAN2 is converted into light for short-distance and medium-distance sensing at a wide VOA and then scans an object in the x-axial direction. The rotational angle of the second scanner SCAN2 may be larger when the second light LB2 travels inside than when the first light LB1 travels inside.

The first light LB1 radiated from the first light source LS1 is reflected by the polarizing filter PF, is reflected by the first scanner SCAN1, reciprocates a short distance in the y-axial direction, and then reciprocates a short distance in the x-axial direction by the second scanner SCAN2. Accordingly, the first light LB1 can precisely and quickly two-dimensionally scan an object at a long distance at a narrow angle in each of the x-axial and y-axial directions. The first light LB1 is reflected by an object at a long distance and then received to the first reception unit SS1.

The second light LB2 radiated from the second light source LS2 passes through the polarizing filter PF and then reciprocates a relatively long distance in the x-axial direction by the second scanner SCAN2. Accordingly, the second light LB2 can precisely 1D scan an object at a short distance and a medium distance at a wide VOA on the x-axis. The second light LB2 is reflected by an object at a short distance and a medium distance and then received to the second reception unit SS2.

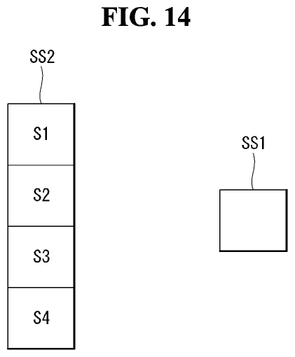

FIG. 14 is a diagram showing the first and second light reception units SS1 and SS2.

Referring to FIG. 14, the first light reception unit SS1 may be implemented as a single photoelectric transformation element. The photoelectric transformation element may be a photodiode. When the first light LB1 is a point light source, the first light LB1 received from an object at a long distance is received to the single photoelectric transformation element. The first light reception unit SS1 converts the light of the point light source into an electrical signal, that is, a current. The point light source is received to the first light reception unit SS1 in synchronization with the pulse of the first light LB1 that scans along the x-axis and the y-axis by the light scan unit SCAN. Accordingly, the first light reception unit SS1 can two-dimensionally (2D) sense an object by performing photoelectric transformation on the light that scans the object in the x-axial direction and the y-axial direction.

The second light reception unit SS2 includes several photoelectric transformation elements S1˜S4 that are one-dimensionally (1D) arranged in the vertical direction (along the y-axis). The photoelectric transformation elements S1˜S4 may be photodiodes. When the second light LB2 is a vertically long linear light source, the linear light source scans in the x-axial direction by the light scan unit SCAN and is reflected by an object, whereby the linear light source is simultaneously received to the first to fourth photoelectric transformation elements S1˜S4. The first photoelectric transformation element S1 senses light reflected by the upper end of the object. The fourth photoelectric transformation element S4 senses light reflected by the lower end of the object. The second and third photoelectric transformation element S2 and S3 sense light reflected by the middle portion of the object. Since the second light LB2 is linear polarized light that is long along the y-axis and moves in the x-axial direction and the photoelectric transformation elements S1 and S2 of the second light reception unit SS2 are divided in the y-axial direction, the second light reception unit SS2 can two-dimensionally (2D) sense objects at a medium distance and a long distance. An output signal of the second light reception unit SS2 is supplied to the second signal processing unit SP2.

The degree of influence on an injury on the retinas of human due to laser light may depend on the wavelength thereof. For example, laser light of 1550 nm is less harmful to the eyes of human than laser light of 905 nm. When the output power of a laser light source of 1550 nm is 106 time larger than the output power of a laser light source of 905 nm, the eye safety level is the same level or higher. Accordingly, even if the power of the laser light source of 1550 nm is increased very higher than that of the laser light source of 905 nm, it is less harmful to the eyes of human. In consideration of this face, as shown in FIG. 5, it is preferable to select a light source for long-distance sensing as the laser light source of 1550 nm as in the example of FIG. 15.

FIG. 15 is a diagram showing in detail a light emission unit according to a second embodiment of the present disclosure.

Referring to FIG. 15, laser light sources of a first light emission unit LS1 and a second light emission unit LS2 are spaced a predetermined apart from each other. First light LB1 that is radiated from the first light emission unit LS1 is larger in wavelength than second light LB2 that is radiated from the second light emission unit LS2. For example, the first light emission unit LS1 is a laser light source of 1550 nm and the second light BL2 may be a laser light source of 905 nm.

The laser light source of the first light emission unit LS1 may be a point light source that radiates light pulses in the shape of a point. The laser light source of the second light emission unit LS2 may be a linear light source that radiates light pulses in the shape of a long line in the y-axial direction.

The light scan unit SCAN includes a wavelength-selective lens WSL, a first scanner SCAN1, and a second scanner SCAN2.

Laser pulses that are radiated from the first and second light sources LS1 and LS2 can be radiated with a predetermined time difference. In this case, the first light LB1 and the second light LB2 may alternately or time-divisionally travel into the wavelength-selective lens WSL.

The wavelength-selective lens WSL is disposed between the first light source

LS1, the second light source LS2, and the first and second scanners SCAN1 and SCAN2. The light traveling into the wavelength-selective lens WSL passes through or is reflected by the wavelength-selective lens WSL, depending on the wavelength thereof. For example, the laser light of 1550 nm is reflected by the wavelength-selective lens WSL, but the laser light of 905 nm passes through the wavelength-selective lens WSL.

The first light BL1 may be the laser light of 1550 nm and the second light LB2 may be the laser light of 905 nm. In this case, the first light BL1 is reflected by the wavelength-selective lens WSL and travels to the first scanner SCAN1. On the other hand, the second light LB2 passes through the wavelength-selective lens WSL and then travels to the second canner SCAN2.

The first scanner SCAN1 may be implemented as a MEMS scanner that resonates in the vertical (y-axial) direction about a rotational axis within a predetermined rotational angle. Light that is reflected by the first scanner SCAN1 is converted into light for long-distance sensing at a wide VOA, thereby being able to scan an object in the y-axial direction. The rotational angle of the first scanner SCAN1 may be smaller than that of the second scanner SCAN2.

The second scanner SCAN2 may be implemented as a MEMS scanner that resonates in the horizontal direction, that is, in the x-axial direction perpendicular to the y-axial direction around a rotational axis within a predetermined angle range. The first light LB1 that is reflected by the second scanner SCAN2 is converted into light for long-distance sensing at a narrow VOA and then scans an object in the x-axial direction. The second light LB2 that is reflected by the second scanner SCAN2 is converted into light for short-distance and medium-distance sensing at a wide VOA and then scans an object in the x-axial direction. The rotational angle of the second scanner SCAN2 may be larger when the second light LB2 travels inside than when the first light LB1 travels inside.

The first light LB1 radiated from the first light source LS1 is reflected by the wavelength-selective lens WSL, is reflected by the first scanner SCAN1, reciprocates a short distance in the y-axial direction, and then reciprocates a short distance in the x-axial direction by the second scanner SCAN2. Accordingly, the first light LB1 can precisely and quickly two-dimensionally scan an object at a long distance at a narrow angle in each of the x-axial and y-axial directions. Even if the output power of the first light source LS1 is increased, the first light LB1 of 1550 nm does not exert a bad influence on the eyes of human. The first light BL1 is reflected by an object at long distance and then received to the first reception unit SS1, as shown in FIG. 14.

The second light LB2 radiated from the second light source LS2 passes through the wavelength-selective lens WSL and then reciprocates a relatively long distance in the x-axial direction by the second scanner SCAN2. Accordingly, the second light LB2 can precisely 1D scan an object at a short distance and a medium distance at a wide VOA on the x-axis. The second light LB2 is reflected by an object at a short distance and a medium distance and then received to the second reception unit SS2 shown in FIG. 14.

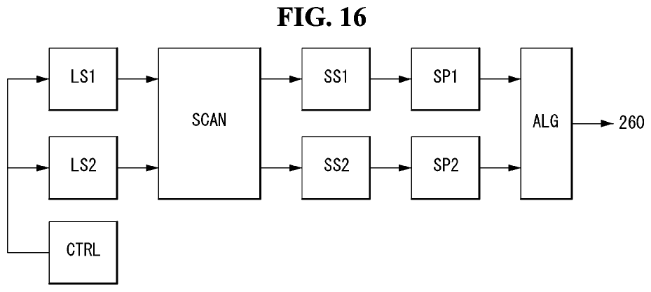

The lidar system may further include a light source control unit CTRL shown in FIG. 16.

The light source control unit CTRL can change the power of the light emission units LS1 and LS2 in accordance with a driving section on the route of the vehicle or the environment in cooperation with the system shown in FIG. 6. For example, the light source control unit CTRL can decrease the intensity of a light source for long-distance sensing by decreasing the power of the first light emission unit LS1 in a downtown area with heavy traffic jams or a congestion section with a large traffic volume. On the contrary, the light source control unit CTRL can increase the detection distance by increasing the intensity of a light source for long-distance sensing by increasing the power of the second light emission unit LS2 in a countryside, a desert downtown area, or a non-congestion section with a small traffic volume on the route.

The laser light of 1550 nm has a characteristic of a high eye safety level even if the power is increased, in comparison to the laser light of 905 nm. The laser light of 1550 nm is less dispersed by moisture in the air in comparison to the laser light of 905 nm, so the loss of the amount of received light is less. The laser light of 905 nm is higher in reflection ratio of sunlight from a pile of snow in comparison to the laser light of 1550 nm. Accordingly, the signal-to-noise ratio of a signal detected through the laser light of 905 nm in a section with a heavy fog or a section with a large pile of snow, so the accuracy in object detection may be low. The object determination unit ALG can provide object information detected by the laser light of 1550 nm having a relatively high signal-to-noise ratio in a section with a heavy fog or a section with a large pile of snow to the autonomous driving device 260.

Various embodiments of the lidar system of the present disclosure are simply and clearly described hereafter.

Embodiment 1: A lidar system includes: a first light source that generates first light in the shape of a point light source; a second light source that generates second light in the shape of a linear light source; a selective reflective optical element that reflects the first light and transmits the second light; a first scanner that vertically reciprocates the first light traveling from the selective reflective optical element; a second scanner that horizontally reciprocates the first and second light traveling from the selective reflective optical element; a first light reception unit that converts the first light reflected by an object at a long distance into an electrical signal; and a second light reception unit that converts the second light reflected by an object at a short distance and a medium distance in to an electrical signal.

Embodiment 2: The first and second light is laser light having the same wavelength.

Embodiment 3: Polarized light of the first light is different from second polarized light.

Embodiment 4: The selective reflective optical element includes a polarizing filter that reflects the first light and transmits the second light.

Embodiment 5: Wavelengths of the first and second light are different from each other.

Embodiment 6: The wavelength of the first light is larger than the wavelength of the second light.

Embodiment 7: The wavelength of the first light is 1550 nm and the wavelength of the second light is 950 nm.

Embodiment 8: The selective reflective optical element includes a wavelength-selective lens that reflects the first light and transmits the second light.

Embodiment 9: The first scanner is smaller in rotational angle than the second scanner.

Embodiment 10: The rotational angle of the second scanner is larger when the second light travels inside than when the first light travels inside.

Embodiment 11: The first light reception unit includes a single photoelectric transformation element that receives first light received from the object at a long distance.

Embodiment 12: The second light reception unit includes several photoelectric transformation elements that receive the second light received from the object at a short distance and a medium distance. The several photoelectric transformation elements are one-dimensionally vertically arranged.

Embodiment 13: The lidar system further includes: a first signal processing unit that outputs data for long-distance sensing by current-voltage-converting, amplifying, and converting an output signal of the first light reception unit into digital data; a second signal processing unit that outputs data for medium-distance and long-distance sensing by current-voltage-converting, amplifying, and converting an output signal of the second light reception unit SS1 into digital data; and an object determination unit that generates object information including distances from objects, and shapes by analyzing the data from the first and second signal processing units, using a TOF (Time of Flight) algorithm or a phase-shift algorithm. The object information from the object determination unit is input to an autonomous driving system.

Embodiment 14: The lidar system further includes a light source control unit that changes output power of the first and second light emission units in accordance with a route of a vehicle and an environment.

Embodiment 15: A view of angle of the first light reflected by the first and second scanners and traveling to the object at a long distance is narrower than a view of angle of the first light reflected by the second scanner and traveling to the object at the short distance and the medium distance.

Embodiments of the autonomous driving system are as follows.

Embodiment 1: The autonomous driving system includes: an object detection device that detects an object outside a vehicle using a lidar system; and an autonomous device that receives object information from the object detection device and reflects the object information to movement control of the vehicle. The lidar system includes: a first light source that generates first light in the shape of a point light source; a second light source that generates second light in the shape of a linear light source; a selective reflective optical element that reflects the first light and transmits the second light; a first scanner that vertically reciprocates the first light traveling from the selective reflective optical element; a second scanner that horizontally reciprocates the first and second light traveling from the selective reflective optical element; a first light reception unit that converts the first light reflected by an object at a long distance into an electrical signal; and a second light reception unit that converts the second light reflected by an object at a short distance and a medium distance in to an electrical signal.

Embodiment 2: The first and second light is laser light having the same wavelength.

Embodiment 3: Polarized light of the first light is different from second polarized light.

Embodiment 4: The selective reflective optical element includes a polarizing filter that reflects the first light and transmits the second light.

Embodiment 5: Wavelengths of the first and second light are different from each other.

Embodiment 6: The wavelength of the first light is 1550 nm and the wavelength of the second light is 950 nm. The selective reflective optical element includes a wavelength-selective lens that reflects the first light and transmits the second light.

Embodiment 7: A view of angle of the first light reflected by the first and second scanners and traveling to the object at a long distance is narrower than a view of angle of the first light reflected by the second scanner and traveling to the object at the short distance and the medium distance.

Embodiment 8: The first scanner is smaller in rotational angle than the second scanner.

Embodiment 9: The rotational angle of the second scanner is larger when the second light travels inside than when the first light travels inside.

Embodiment 10: The first light reception unit includes a single photoelectric transformation element that receives first light received from the object at a long distance.

Embodiment 11: The second light reception unit includes several photoelectric transformation elements that receive the second light received from the object at a short distance and a medium distance. The several photoelectric transformation elements are one-dimensionally vertically arranged.

Embodiment 12: The lidar system further includes: a first signal processing unit that outputs data for long-distance sensing by current-voltage-converting, amplifying, and converting an output signal of the first light reception unit into digital data; a second signal processing unit that outputs data for medium-distance and long-distance sensing by current-voltage-converting, amplifying, and converting an output signal of the second light reception unit SS1 into digital data; and an object determination unit that generates object information including distances from objects, and shapes by analyzing the data from the first and second signal processing units, using a TOF (Time of Flight) algorithm or a phase-shift algorithm. The object information from the object determination unit is input to the autonomous device.

Embodiment 13: The lidar system further includes a light source control unit that changes output power of the first and second light emission units in accordance with a route of a vehicle and an environment.

The present disclosure senses a long-distance object using two one-dimensional scanners in a narrow are and senses a short-distance and medium-distance object using one one-dimensional scanner of the two scanners, using first and second laser light sources.

The present disclosure can flexibly apply an object detection method from detectable short distance to long distance, depending on use cases.

The present disclosure can implement an optical system of a light emission unit using two light sources, two one-dimensional scanners, and one selective reflective optical element, and can implement a lidar system that is small and light and can decrease the costs.

Further, the present disclosure can increase safety in autonomous driving by accurately detecting an object by adoptively changing an object detection method in accordance with a driving environment.

The effects of the present disclosure are not limited to the effects described above and other effects can be clearly understood by those skilled in the art from the following description.

The present disclosure can be achieved by computer-readable codes on a program-recoded medium. A computer-readable medium includes all kinds of recording devices that keep data that can be read by a computer system. For example, the computer-readable medium may be an HDD (Hard Disk Drive), an SSD (Solid State Disk), an SDD (Silicon Disk Drive), a ROM, a RAM, a CD-ROM, a magnetic tape, a floppy disk, and an optical data storage, and may also be implemented in a carrier wave type (for example, transmission using the internet). Accordingly, the detailed description should not be construed as being limited in all respects and should be construed as an example. The scope of the present disclosure should be determined by reasonable analysis of the claims and all changes within an equivalent range of the present disclosure is included in the scope of the present disclosure.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A lidar system comprising:
a first light source that generates first light in the shape of a point light source;
a second light source that generates second light in the shape of a linear light source;
a selective reflective optical element that reflects the first light and transmits the second light;
a first scanner that vertically reciprocates the first light traveling from the selective reflective optical element;
a second scanner that horizontally reciprocates the first and second light traveling from the selective reflective optical element;
a first light reception unit that converts the first light reflected by an object at a long distance into an electrical signal; and
a second light reception unit that converts the second light reflected by an object at a short distance and a medium distance in to an electrical signal.

2. The lidar system of claim 1, wherein the first and second light is laser light having the same wavelength.

3. The lidar system of claim 2, wherein polarized light of the first light is different from second polarized light.

4. The lidar system of claim 3, wherein the selective reflective optical element includes a polarizing filter that reflects the first light and transmits the second light.

5. The lidar system of claim 1, wherein wavelengths of the first and second light are different from each other.

6. The lidar system of claim 1, wherein the wavelength of the first light is larger than the wavelength of the second light.

7. The lidar system of claim 6, wherein the wavelength of the first light is 1550 nm and the wavelength of the second light is 950 nm.

8. The lidar system of claim 7, wherein the selective reflective optical element includes a wavelength-selective lens that reflects the first light and transmits the second light.

9. The lidar system of claim 1, wherein the first scanner is smaller in rotational angle than the second scanner.

10. The lidar system of claim 9, wherein the rotational angle of the second scanner is larger when the second light travels inside than when the first light travels inside.

11. The lidar system of claim 1, wherein the first light reception unit includes a single photoelectric transformation element that receives first light received from the object at a long distance.

12. The lidar system of claim 11, wherein the second light reception unit includes several photoelectric transformation elements that receive the second light received from the object at a short distance and a medium distance, and the several photoelectric transformation elements are one-dimensionally vertically arranged.

13. The lidar system of claim 1, further comprising:
a first signal processing unit that outputs data for long-distance sensing by current-voltage-converting, amplifying, and converting an output signal of the first light reception unit into digital data;
a second signal processing unit that outputs data for medium-distance and long-distance sensing by current-voltage-converting, amplifying, and converting an output signal of the second light reception unit SS1 into digital data; and
an object determination unit that generates object information including distances from objects, and shapes by analyzing the data from the first and second signal processing units, using a TOF (Time of Flight) algorithm or a phase-shift algorithm,
wherein the object information from the object determination unit is input to an autonomous driving system.

14. The lidar system of claim 13, further comprising a light source control unit that changes output power of the first and second light emission units in accordance with a route of a vehicle and an environment.

15. The lidar system of claim 1, wherein a view of angle of the first light reflected by the first and second scanners and traveling to the object at a long distance is narrower than a view of angle of the first light reflected by the second scanner and traveling to the object at the short distance and the medium distance.

16. An autonomous driving system comprising:
an object detection device that detects an object outside a vehicle using a lidar system; and
an autonomous device that receives object information from the object detection device and reflects the object information to movement control of the vehicle,
wherein the lidar system includes:
a first light source that generates first light in the shape of a point light source;
a second light source that generates second light in the shape of a linear light source;
a selective reflective optical element that reflects the first light and transmits the second light;
a first scanner that vertically reciprocates the first light traveling from the selective reflective optical element;
a second scanner that horizontally reciprocates the first and second light traveling from the selective reflective optical element;
a first light reception unit that converts the first light reflected by an object at a long distance into an electrical signal; and
a second light reception unit that converts the second light reflected by an object at a short distance and a medium distance in to an electrical signal.

17. The autonomous driving system of claim 16, wherein the first and second light is laser light having the same wavelength.

18. The autonomous driving system of claim 17, wherein polarized light of the first light is different from second polarized light.

19. The autonomous driving system of claim 18, wherein the selective reflective optical element includes a polarizing filter that reflects the first light and transmits the second light.

20. The autonomous driving system of claim 16, wherein the wavelength of the first light is 1550 nm and the wavelength of the second light is 950 nm, and
the selective reflective optical element includes a wavelength-selective lens that reflects the first light and transmits the second light.
